(19) United States
(12) Patent Application Publication
(10) Pub. No.: US 2006/0266578 A1
(43) Pub. Date: Nov. 30, 2006

(54) Speaker diaphragm and method for manufacturing the same

(75) Inventors: Koji Takayama, Yamagata (JP); Masatoshi Sato, Yamagata (JP); Hiroyuki Kobayashi, Yamagata (JP)

Correspondence Address: ARENT FOX PLLC, 1050 CONNECTICUT AVENUE, N.W., SUITE 400, WASHINGTON, DC, 20036, US

(73) Assignees: PIONEER CORPORATION; TOHOKU PIONEER CORPORATION

(21) Appl. No.: 11/436,996

(22) Filed: May 19, 2006

(30) Foreign Application Priority Data
May 20, 2005 (JP) 2005-148352

(51) Int. Cl. H04R 7/00

(52) U.S. Cl. 181/167

(57) ABSTRACT

A speaker diaphragm is formed with a woven cloth as a base material. The woven cloth is formed with fibers made through mixing a natural fiber with a chemical fiber. Thereby, provided is the speaker diaphragm which has a high strength, a superior durability when inputting high power, a high environmental resistance, ability with an easy adjustment of sound quality characteristic, good-broad reproduction frequency characteristic, and a superior formability.

### BACKGROUND OF THE INVENTION

The present invention relates to a speaker diaphragm and a method for manufacturing the same.

The present application claims priority from Japanese Patent Application No. 2005-148352, the disclosure of which is incorporated herein by reference.

The speaker diaphragm is formed with a various kind of material to obtain the respective characteristics according to various sound reproduction bands, or to meet with an environment of its use. In general, as a characteristic of speaker, any material having a large relative elastic modulus (E/ρ) is useful in order to heighten eigenfrequency, so that a good characteristic of vibration region can be expanded. In addition, any material having a large internal loss is preferable for suppressing a peak of resonance, which occurs at the eigenfrequency, to flatten a reproduction frequency characteristic.

In general, a paper material, which has been adopted as material of the speaker diaphragm for a long time, has characteristics of a low density and a large internal loss. It has, however, a problem of low durability when a large input is applied thereto, due to a low elastic modulus E and a low strength against a bending stress. In addition, since the paper material has a high hygroscopic property, the characteristics are exposed to change according to the environment of its use. In other words, it has also a problem of a low environmental resistance.

On the other hand, a speaker diaphragm having a high strength and a high environmental resistance employs a cloth woven either singly or mixedly with the following materials, as a base material of the diaphragm. The material of the woven cloth is an inorganic fiber such as carbon fiber and glass fiber, or an organic fiber such as aramid fiber having a high crystallization and a high heat resistance.

For instance, Japanese Patent Application Laid-open No. Hei 6-165289 discloses a diaphragm which employs the carbon fiber as a warp thereof, and the same carbon fiber and a polycarbonate fiber as a weft thereof, in the woven cloth of the base material, wherein the warp and the weft woven with each other create a three-dimensional structure. According to the prior art, it is described that there is provided a speaker diaphragm which enables a reproduction frequency thereof to expand toward the high frequency side, obtains a high sound quality, and has a high input resistance.

Such a conventional speaker diaphragm, however, employs only a chemical fiber in the woven cloth as the base material. Although there is an advantage that no divided resonance is caused when the diaphragm is operated since there occurs no orientation in strength and rigidity due to homogeneity of formed objects, there is a problem that an adjustment for getting a desired characteristic is difficult since a property of the diaphragm is subject to the material of the woven cloth due to the high homogeneity of the object. In particular, it is preferable that a various kind of adjusting parameters exist for improving a sound quality of the speaker. According to the prior art, however, it is difficult to adjust it to a characteristic of desired sound quality.

Further, in the conventional technique of manufacturing a diaphragm which forms a base material thereof with a woven cloth made of only chemical fiber and then impregnates a thermosetting resin into the base material to form the diaphragm, there is another problem that the flattened-broad reproduction frequency characteristic can not be obtained due to a small internal loss. Additionally, there also exists a further problem that a forming failure thereof may occur in the technique employing only the chemical fiber since textures are not stably made due to slip of the respective fibers when forming the resin into a shape of the diaphragm.

### SUMMARY OF THE INVENTION

In view of the foregoing, an object of the present invention is to solve the foregoing problems of the conventional techniques. That is, it is to provide a speaker diaphragm which has a high strength, a superior durability when inputting high power, a high environmental resistance, ability with an easy adjustment of sound quality characteristic, a good-broad reproduction frequency characteristic, and a superior formability.

To achieve the foregoing object, a speaker diaphragm and a method for manufacturing the same according to the present invention shall comprise at least components set forth in the following aspects.

One aspect of the present invention is a speaker diaphragm comprising a chemical fiber, a natural fiber being mixed with the chemical fiber, and a woven cloth as a base material of the speaker diaphragm, wherein the woven cloth is formed by fibers mixing the natural fiber with the chemical fiber.

Another aspect of the present invention is a method for manufacturing a speaker diaphragm, comprising the steps of forming fibers by mixing a natural fiber with a chemical fiber, forming a woven cloth as a base material of the speaker diaphragm with the fibers, impregnating a thermosetting resin into the base material, and performing a hot forming of the base material.

### BRIEF DESCRIPTION OF THE DRAWINGS

These and other objects and advantages of the present invention will become clear from the following description with reference to the accompanying drawings, wherein:

FIG. 1A is a plan view of a speaker diaphragm according to an embodiment of the present invention;

FIG. 1B is a partially enlarged view of the speaker diaphragm of FIG. 1A;

FIGS. 2A and 2B are explanatory views showing the respective construction examples of fiber, which is employed in a speaker diaphragm, according to embodiments of the present invention; and

FIG. 3 is an explanatory view showing an example of speaker with the diaphragm according to the embodiment of the present invention.

### DETAILED DESCRIPTION OF THE PREFERRED EMBODIMENTS

Hereinafter, most preferred embodiments of the present invention will be described in detail with reference to the drawings.

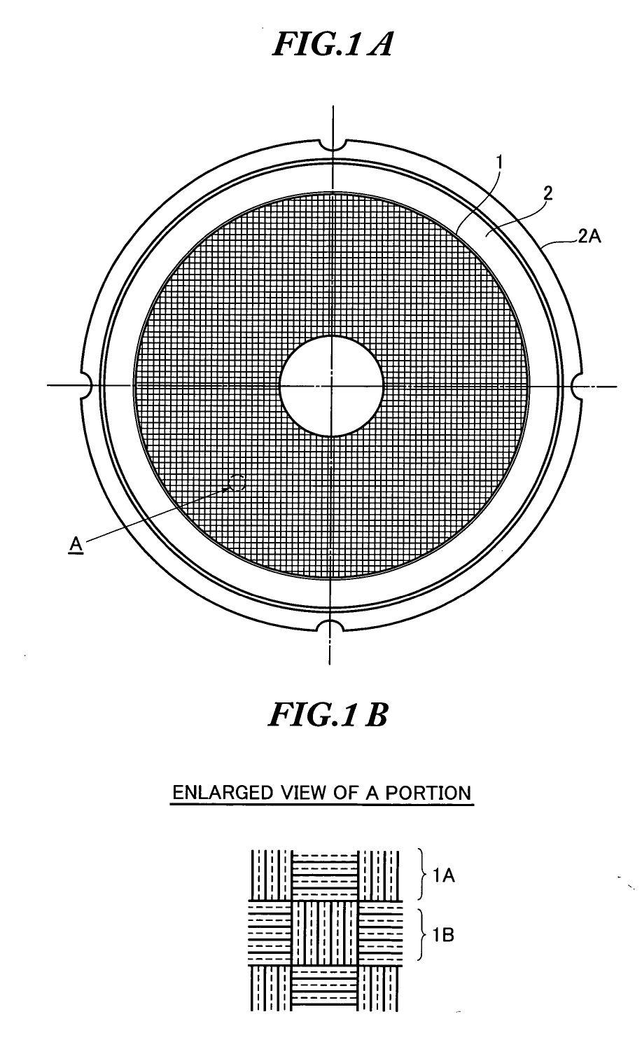

As shown in FIG. 1A, which is a plan view showing a cone-type diaphragm, a diaphragm 1 has an edge 2 formed around itself, and an attaching member 2A for attaching the diaphragm 1 to a speaker frame at an outer rim of the edge 2. In the embodiment of the present invention, a base material of the diaphragm 1 is made of a woven cloth, in which the woven cloth is formed through mixing a natural fiber in a chemical fiber.

FIG. 1B is an enlarged view of A-portion of the diaphragm 1 as shown in FIG. 1A. The diaphragm 1 as one example is formed by weaving a warp 1A and a weft 1B together, in which the natural fiber is mixed in both the warp 1A and the weft 1B. Moreover, the natural fiber is indicated by a broken line in FIG. 1B. Having no limitation to this example, the natural fiber may be mixed in either the warp 1A or the weft 1B.

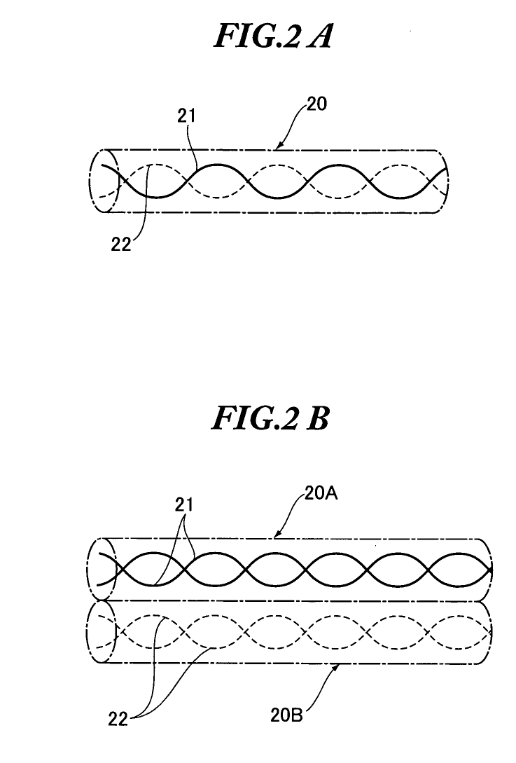

FIGS. 2A and 2B show construction examples of fiber employed in the woven cloth of the present invention. FIG. 2A shows an example in which one fiber comprises a twist yarn 20 including a chemical fiber 21 and one or a plurality of natural fibers 22. Forming a woven cloth with the twist yarn 20 can provide a woven cloth in which a natural fiber is added to a chemical fiber. On the other hand, in FIG. 2B, a twist yarn 20A of a chemical fiber 21 and a twist yarn 20B of the natural fiber 22 are mixed with each other to form the warp 1A or the weft 1B. The embodiments of the present invention are not limited to these cases, but the other construction examples of fiber may also be included in the claimed invention.

Preferably, the chemical fiber set forth in the foregoing includes an aramid fiber, a carbon fiber, a glass fiber, a PEN (polyethylene naphthalate) fiber, or a PET (polyethylene terephthalate) fiber, a PBO (poly-phenylene-benzobisoxazole) fiber, and also the natural fiber includes a silk fiber or a cotton fiber.

An explanation of a method for manufacturing the diaphragm 1 will be given hereinafter. First, a base material which comprises a woven fiber mixing a natural fiber in a chemical fiber is formed. Here, it is preferable that a mixing ratio of the natural fiber is less than 30%. If so many natural fibers are mixed in the woven cloth, a desired characteristic can not be obtained since the weight of diaphragm is increased due to a high liquid absorption property of the natural fiber itself. Further, an environmental resistance may be lowered. Then, after impregnating thermosetting resin into the formed base material, a hot forming thereof is performed to obtain a desired-shaped diaphragm.

According to the embodiment of the present invention, there occurs a difference in a permeation degree of the impregnation solution. More specifically, the difference between the liquid absorption property of chemical fiber and that of natural fiber causes the difference in the permeation degree when the natural fiber is mixed with the chemical fiber and then the resin is impregnated into. As a result, a portion where much thermosetting resin liquid is absorbed becomes hard, and also a portion where little thermosetting resin liquid is absorbed becomes soft. Thereby, the hard portion and the soft portion appear therein after forming the speaker diaphragm, which causes a dispersion resonance to enable the diaphragm to obtain the flattened-broad reproduction frequency characteristic.

Additionally, while the base material consisting of only chemical fiber is apt to cause a slip between the fibers, that is, the texture is not stable, mixing the natural fiber with the chemical fiber increases a friction resistance between the fibers, so that the diaphragm with a stable texture can be formed. In other words, forming property of the diaphragm can be improved.

Furthermore, the mixture of the natural fiber increases internal loss, so that the flattened-broad reproduction frequency characteristic can be obtained. Through adjusting a mixture ratio of the natural fiber, the characteristic of the internal loss and a degree of the dispersion resonance can be adjusted. Thereby, it enables the sound quality characteristic to be adjusted to a desired characteristic.

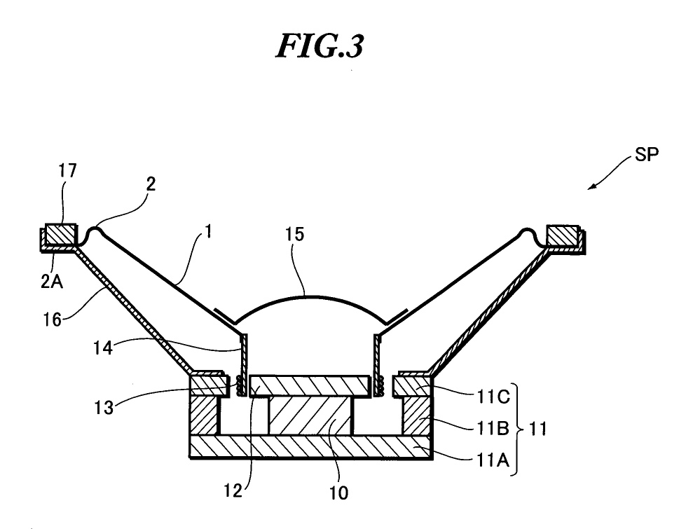

FIG. 3 shows an example of speaker with the diaphragm 1 according to the embodiment of the present invention. Here, the speaker with a cone-type diaphragm is shown therein, but a dome-type diaphragm or a plane-type one may be applied to the speaker.

A speaker SP as shown in FIG. 3 is provided with a magnet 10, a yoke 11 attached on a bottom surface of the magnet 10, a center plate 12 attached on an upper surface of the magnet 10, a voice coil 13, a voice coil bobbin 14, the diaphragm 1, and a center cap 15.

The magnet 10 has a high magnetic flux density such as that of neodymium magnet under a shape of circular plate. The yoke 11 comprises a bottom plate 11A, a side wall 11B, and an annular plate 11C, all of which are, for example, made of magnetic material such as iron or an alloy thereof. A magnetic gap is formed between an internal periphery surface of the annular plate 11C and an outer periphery surface of the center plate 12. The magnetic gap, the magnet 10 and the yoke 11 form a magnetic circuit. The center plate 12 also comprises magnetic material such as an iron or an alloy thereof, and is in a circular shape on the magnet 10.

The voice coil bobbin 14 is disposed so as to arrange the voice coil 13 within the magnetic gap, and transmits vibration as generated by signals being input into the voice coil 13 to the diaphragm 1.

As set forth in the forgoing, the diaphragm 1 is formed through making a woven cloth with fibers mixing a silk fiber (natural fiber) with an aramid fiber (chemical fiber) as a base material, and impregnating a thermosetting resin into the base material, and lastly performing a hot forming thereon. Also, the diaphragm 1 is fixed on an outer periphery rim portion of the speaker frame 16 which is mounted on the yoke 11 via the attaching member 2A of the edge 2. A gasket 17 for ensuring air tightness inside the speaker frame 16 is mounted on the outer periphery edge portion of the speaker frame 16 where the attaching member 2A of the edge 2 is fixed in the same fashion.

Since the speaker SP employs the diaphragm 1 having the forgoing features, the durability in the operation of inputting high power is high, and also the good-broad reproduction frequency characteristic can be obtained.

As mentioned above, according to the present invention, it becomes possible to provide a speaker diaphragm which has a high strength, a superior durability when inputting high power, a high environmental resistance, ability with an easy adjustment of sound quality characteristic, good-broad reproduction frequency characteristic, and a superior formability.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A speaker diaphragm comprising:
a chemical fiber;
a natural fiber being mixed with said chemical fiber; and
a woven cloth as a base material of the speaker diaphragm,
wherein said woven cloth is formed by fibers mixing said natural fiber with said chemical fiber.

2. The speaker diaphragm according to claim 1, wherein
said woven cloth is formed by weaving a warp and a weft, and
said natural fiber is mixed in either the warp or the weft, or both.

3. The speaker diaphragm according to claim 1, wherein
said woven cloth is formed by weaving a warp and a weft, and
a twist yarn including the chemical fiber and one or a plurality of natural fibers is mixed in either the warp or the weft, or both.

4. A method for manufacturing a speaker diaphragm, comprising the steps of:
forming fibers by mixing a natural fiber with a chemical fiber;
forming a woven cloth as a base material of the speaker diaphragm with said fibers;
impregnating a thermosetting resin into said base material; and
performing a hot forming of said base material.
